(19) United States
(12) Patent Application Publication
(10) Pub. No.: US 2006/0176557 A1
(43) Pub. Date: Aug. 10, 2006

(54) 2D/3D compatible display system

(76) Inventors: Adrian Travis, Clare College (GB); Robert Kory, Los Angeles, CA (US); Dan Mapes, Los Angeles, CA (US); Soohyun Cha, Woodland Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/054,780

(22) Filed: Feb. 9, 2005

(51) Int. Cl. G02B 27/22

(52) U.S. Cl. 359/462

(57) ABSTRACT

A display system operates in both an autostereoscopic 3D display mode and a 2D display mode. A switchable optical diffuser is placed in the view path. The diffuser is transparent in the 3D display mode, but is diffusive in the 2D display mode to provide an increased field of view.

### BACKGROUND OF THE INVENTION

1. Field of the Invention

This invention relates generally to the field of video display systems. More particularly, the invention relates to an autostereoscopic system for presenting a three dimensional display that can also be operated in a two dimensional mode with an enhanced field of view.

2. Background

Time multiplexing technology for achieving a three dimensional display is described in U.S. Pat. No. 5,132,839. The system disclosed therein comprises a backlighting apparatus for projecting beams of light in selected directions, a spatial light modulator for displaying images back lit by the backlighting apparatus and a control system coupled to both the spatial light modulator and the backlighting apparatus. The control system causes a plurality of images of an object to be formed in succession on the spatial light modulator with each image being a view of the subject form a different angle, and each image being viewable only from particular angles. The images are formed one at a time on the spatial light modulator with a plurality of images constituting a single frame of a video picture. In the described embodiments, the backlighting apparatus includes a two dimensional display device for emitting spots of lights at selected locations along the two dimensional display, and a lens system for refracting light emitted by the two dimensional display device. The lens system refracts beams emanating from a spot of light on the two dimensional display into substantially parallel rays. The different individual views of the subject are thus projected onto an image plane at discrete horizontal positions, the positions being spaced apart by a distance that is less than the inter-occular spacing of a human. An observer is thus presented with a stereoscopic view of the subject. Furthermore, a sufficient number of different views are provided so that the observer may move from side to side to “see” the subject from different angles.

The number of different view angles in such an autostereoscopic display system is limited by practical considerations. Thus, the horizontal field of view is necessarily limited.

A display system such as described above need not be used exclusively for three dimensional presentation. The system is inherently capable of also presenting conventional two dimensional images. Without modification, the field of view for two dimensional images would be the same as that for three dimensional images. It is desirable, however, to have a wider field of view for larger audiences.

### SUMMARY OF THE INVENTION

The present invention provides a display system that operates in both an autostereoscopic 3D display mode and a 2D display mode. A switchable optical diffuser is placed in the view path. The diffuser is transparent in the 3D display mode, but is diffusive in the 2D display mode to provide an increased field of view.

### BRIEF DESCRIPTION OF THE DRAWINGS

FIG. 1 is a schematic diagram of an auto-stereoscopic display system.

FIG. 2 is a schematic diagram of a display system in accordance with one embodiment of the present invention.

FIG. 3 is a schematic cross-sectional view of a diffuser suitable for use with the present invention.

FIG. 4 is a schematic diagram of a display system in accordance with a second embodiment of the present invention.

FIG. 5 is a schematic diagram of a display system in accordance with a third embodiment of the present invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

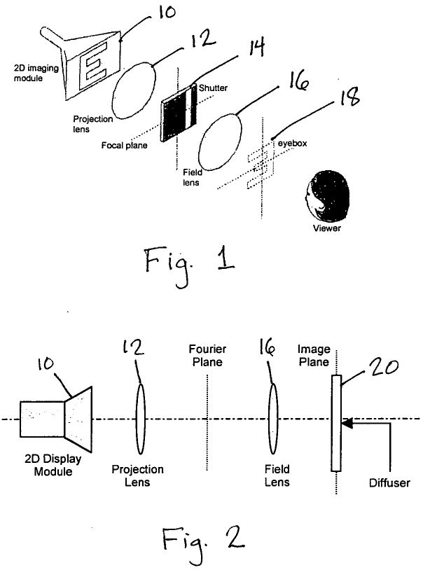

FIG. 1 is a schematic diagram of a prior art display system producing an auto-stereoscopic 3D display. Such a system is more fully described, for example, in U.S. Pat. No. 5,132,829, the disclosure which is incorporated herein by reference. The system comprises an imaging module 10, such as a CRT or other light projecting imaging device. The image generated by module 10 is focused by projection lens 12 onto a focal plane in which a spatial light modulator or shutter 14 is placed. In the three dimensional mode of operation, imaging module 10 generates a plurality of images of an object in succession, each image being a view of the subject from a different angle. Spatial light modulator 14 is synchronized with the succession of images so that each image is viewable only from a corresponding viewing angle. The images are focused by field lens 16 at a respective eye box 18. This arrangement provides a realistic three dimensional viewing experience, but provides a very limited field of view for two dimensional images.

Referring to FIG. 2, a diffuser 20 may be placed in the image plane to increase the field of view for two dimensional images. Diffuser 20 may be a simple diffusive screen that is placed in the image plane for two dimensional viewing and is removed for three dimensional viewing. Preferably, however, diffuser 20 is electrically switchable between a transparent state for three dimensional viewing and a diffusive state for two dimensional viewing. Such a diffuser can be realized, for example, using a glass substrate coated with an electrochromic material. Electrochromism refers to the reversible color/transparency change of electrochromic materials, during the electrochemical redox reaction. For a typical example of tungsten oxide, the phenomenon is described as:

$${W {O}_{3} + x ( {Li}^{+} + {e}^{-} )}_{colorless} ↔ {{Li}_{x} W {O}_{3}}_{blue}$$

Some well-known electrochromic materials are shown in the following table:

| | Inorganic | Organic |
|---|---|---|
| Cathodic | WO₃, MoO₃, TiO₂, . . . | . . . |
| Anodic | NiO₂, IrO₂, RhO₂, . . . | Polyaniline, Polypyrrole, |
| | | Prussian blue, . . . |

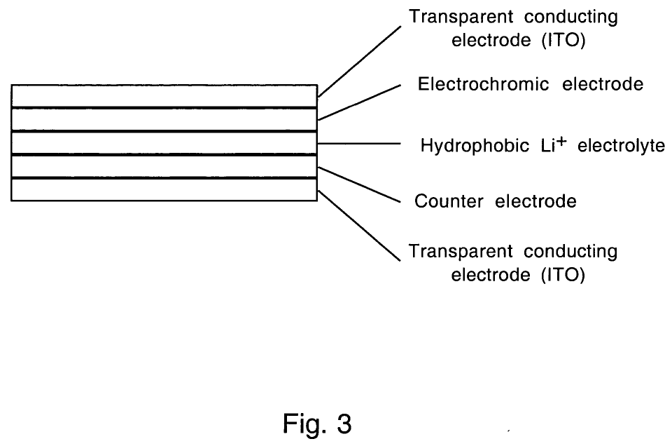

FIG. 3 is a schematic cross-sectional view of a coating for diffuser 20 wherein electrochromic materials are processed into a thin film utilizing a spin coating technique.

For 2D/3D viewing application, transparent thin films of copper oxide on conductive SnO₂:F glass substrate by anodic oxidation of sputtered copper films or by direct electodeposition of Cu₂O transformed reversibly to opaque metallic copper films when reduced in alkaline electrolyte. Copper oxide to copper switching covered a large dynamic range, from 85% and 10% photopic transmittance, with a coloration efficiency of about 32 cm²/C.

For 3D viewing, the transparency is set at maximum. In 2D viewing, the transparency can be changed for forming the image on it.

Other types of materials may be used to realize an electrically switchable diffuser. For example, a polymer dispersed liquid crystal (PDLC) may be utilized. PDLC usually consists of micron-sized liquid crystal droplets dispersed in a polymer matrix. The droplets are randomly distributed in the matrix and they are close in size to visible wavelengths. As a result, light scattering originating from the refractive index mismatch between the liquid crystal droplets and the polymer matrix is strong. A normal mode PDLC is translucent in the voltage-off state. As the applied voltage increases, the crystals are reoriented by the electric field. If the ordinary refractive index of the liquid crystals matches well with the refractive index of the polymer matrix, the film becomes transparent.

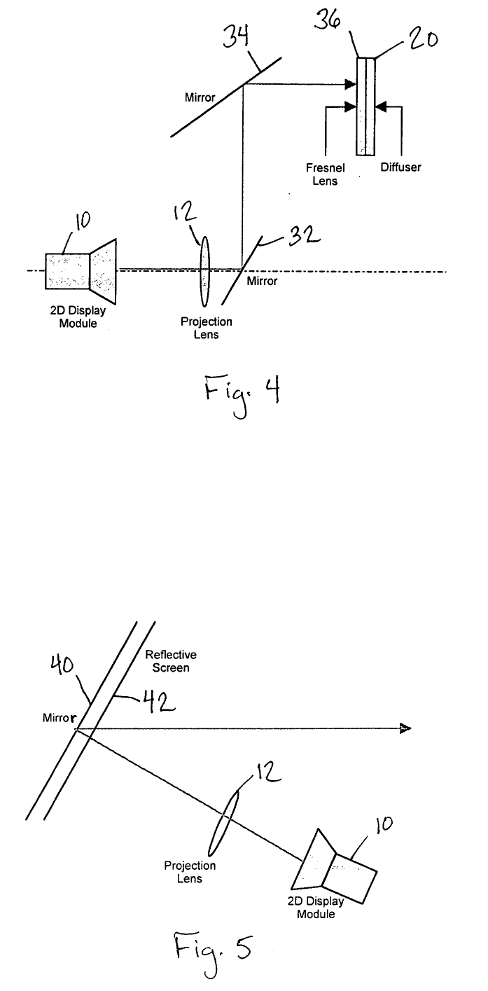

FIG. 4 illustrates a 2D/3D compatible display system arranged for rear projection. Mirrors 32 and 34 project the images from image module 10 to field lens 36, which may be a Fresnel lens. Diffuser 20 is disposed adjacent to lens 36. As described above, diffuser 20 is switchable between a transparent state for viewing three dimensional images and a diffusive state for viewing two dimensional images.

FIG. 5 illustrates a 2D/3D compatible display system arranged for front projection. In a 3D mode of operation, images from module 10 are reflected by mirror 40 for presentation to the viewer. Screen 42 is maintained in a transparent state while the system operates in the 3D mode. In a 2D mode of operation, screen 42 is placed in a reflective state to form a projection screen onto which the images from module 10 are projected for viewing over a relatively wider field of view in comparison to the 3D mode.

While the invention has been described in the context of an autostereoscopic display system of the type disclosed in U.S. Pat. No. 5,132,839, it is not limited in this regard. It may also be applied to a multi-projector 3D display system such as disclosed in U.S. Pat. No. 6,481,849, wherein a plurality of image sources is associated with a corresponding plurality of spatial light modulators to provide an extended field of view. Furthermore, the invention may be utilized with spatial multiplexing or volumetric approaches to 3D presentation.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A video display system having 2D and 3D modes of operation comprising:
an image source;
means for presenting images from the image source as stereoscopic images in a 3D mode of operation;
an optical diffuser disposed in an image plane of the video display system, the diffuser switchable between a transparent state in the 3D mode of operation and a diffusive state in a 2D mode of operation.

2. The video display system of claim 1 wherein the diffuser comprises a film of an electrochromic material.

3. The video display system of claim 1 wherein the diffuser comprises a film of a polymer dispersed liquid crystal.

4. The video display system of claim 1 further comprising a lens focusing an image from the image source onto the image plane.

5. The video display system of claim 4 wherein the lens is a Fresnel lens.

6. The video display system of claim 1 wherein the image source projects an image from behind the diffuser.

7. The video display system of claim 1 further comprising a mirror reflecting an image from the image source in the 3D mode of operation and wherein the diffuser is disposed in front of the mirror so as to form a projection screen in the 2D mode of operation.

8. The video display system of claim 1 wherein the means for presenting images comprise a spatial light modulator coupled to the image source and a control system coupled to the image source and the spatial light modulator to form an autostereoscopic display in the 3D mode of operation.

9. The video display system of claim 8 wherein the image source is one of a plurality of image sources and the spatial light modulator is one of a plurality of spatial light modulators, each coupled to a respective one of the plurality of image sources.
